(19) United States
(12) Patent Application Publication
(10) Pub. No.: US 2002/0093828 A1
(43) Pub. Date: Jul. 18, 2002

(54) Vehicle headlight having a reflector and a horizontal light source transverse to an optical axis of the reflector

(76) Inventor: Herve Perrin, Bobigny Cedex (FR)

Correspondence Address: MORGAN & FINNEGAN, L.L.P., 345 PARK AVENUE, NEW YORK, NY, 10154, US

(21) Appl. No.: 10/023,315

(22) Filed: Dec. 17, 2001

(30) Foreign Application Priority Data
Dec. 28, 2000 (FR) 0017188

(51) Int. Cl. F21V 7/00

(52) U.S. Cl. 362/517; 362/518; 362/297; 362/346

(57) ABSTRACT

A vehicle headlamp comprises a reflector and a horizontal light source oriented transversely to an optical axis of the reflector. The headlamp is arranged to give an American passing beam, i.e. a cut-off beam which is delimited by two half planes at different heights. The reflector is divided into sectors. The orientation of one of these sectors is obtained geometrically by rotating the sector about a horizontal axis transverse to the optical axis, from a position in which the sector is continuous with adjacent sectors, into a position in which that sector will generate images situated at the limit of the higher of the two half planes delimiting the cut-off line.

### FIELD OF THE INVENTION

This invention relates to motor vehicle headlights having a transversely oriented horizontal light source.

### BACKGROUND OF THE INVENTION

It is known from French patent specification FR 2 774 149, in the name of the Company Valeo Vision, to provide a motor vehicle headlight which includes a transverse light source and a reflector in which different rectangular sectors, aligned in the vertical direction, are defined. Each of these sectors has a geometrical surface which is defined and oriented in such a way that the reflector as a whole produces a cut-off beam which is delimited on one side by a horizontal half plane coincident with the horizon line, and on the other side by a half plane which is inclined by an angle of lift of the cut-off line of 15°, as required by regulations. This beam is a European type passing or dipped beam. Such a reflector, which may be called a “complex surface” reflector (Trade Mark) gives good light distribution and particularly well defined cut-off.

It is now thought desirable to produce a “complex surface” reflector which is adapted to generate a cut-off beam that will serve as an American passing beam, i.e. a beam that complies with current United States legislation, that is to say a cut-off beam delimited in its upper part by two horizontal half planes which are at different heights. Ways are therefore being sought to obtain an American passing beam which is delimited by two horizontal half planes, by means of a complex surface reflector that procures a light distribution giving particular satisfaction with clear, crisp cut-off definition. Well before the above mentioned French patent, the Company Valeo Vision had described in French patent specification No. FR 2 602 306 a headlight which produced an American passing beam from a transverse light source. However, the light distribution and the clarity of definition of the cut-off obtained with that arrangement both left some room for improvement.

### DISCUSSION OF THE INVENTION

With a view to achieving such improvement, according to the present invention, a vehicle headlight, comprising a reflector and a horizontal light source oriented transversely to an optical axis of the reflector, the headlight being arranged to generate a cut-off beam delimited by two half planes situated at different heights, is characterised in that the reflector includes a sector of reflective surface which is defined geometrically by rotation of the sector about a horizontal axis transverse to the optical axis, from a position in which the sector is continuous, without discontinuity, with adjacent sectors of the reflector, the said sector being so arranged as to generate images situated at the limit of the half plane which is the higher of the two said half planes.

Thus, the sector obtained by rotation takes certain images of the source below the upper half plane of the cut-off. The cut-off, for example that of the American passing beam, is therefore effected in a clearly defined way and without detriment to the distribution of the whole of the light in the beam.

The headlight according to the invention may in addition have at least one of the following features:

the sectors of the reflector, other than the one obtained by rotation (which will be referred to here as the first sector) are so arranged as to generate images of the source all of which lie at a height below or the same as that of the lower of the two said half planes;

the said first sector has a vertical generatrix which is so arranged that there is constant emission direction such that, for any point on the generatrix, a light ray emitted tangentially by an edge of the light source is reflected by that point parallel to the emission direction, and the light rays emitted by the remainder of the light source are reflected by that point with a downward inclination with respect to the emission direction;

the reflector includes at least one other sector besides the first sector, each said other sector having a vertical generatrix such that, for any point on the latter, a light ray emitted tangentially by an edge of the source is reflected by that point parallel to the optical axis, and the light rays emitted by the remainder of the source are reflected by that point in a downward inclination with respect to the optical axis;

the headlight is so arranged that all the said other sectors of the reflector generate a portion of cut-off beam which is entirely delimited by a horizontal plane at the same height as the lower of the two half planes;

the headlight is so arranged that, if the said first reflector sector were occupying its original position, i.e. its position before the said rotation took place as explained above, then the headlight would generate a cut-off beam which was entirely delimited by a horizontal plane lying at the height of the lower of the two said half planes;

the said first reflector sector is at least partly beyond a lateral end of the light source as seen in front view on the reflector;

the said first reflector sector has a vertical edge aligned with a lateral end of the light source;

the said first reflector sector lies in a lower half of the reflector;

the said first reflector sector extends between an upper or lower edge of the reflector and an essentially horizontal plane passing close to the light source;

the said first reflector sector has, in the front view on the reflector, a generally trapezoidal form with a generally vertical major axis;

the axis of rotation extends to a lower end of the said first reflector sector;

the first reflector sector and/or at least one of the other sectors of the reflector has an essentially horizontal, parabolic, generatrix; and

the reflector has a height greater than its width.

Further features and advantages of the invention will appear more clearly on a reading of the following detailed description of a preferred embodiment of the invention, which is given by way of non-limiting example only and with reference to the accompanying drawings.

### BRIEF DESCRIPTION OF THE DRAWINGS

FIG. 1 is a diagrammatic view of the cut-off of a dipped or passing beam in conformity with United States regulations.

FIG. 2 is a rear view of the reflector of a headlight according to a preferred embodiment of the invention.

FIG. 3 is a view on an enlarged scale, showing the light source and the sector obtained by rotation (the “first sector” discussed above), in the reflector of FIG. 2.

FIG. 4 is a view in vertical axial cross section of the reflector of

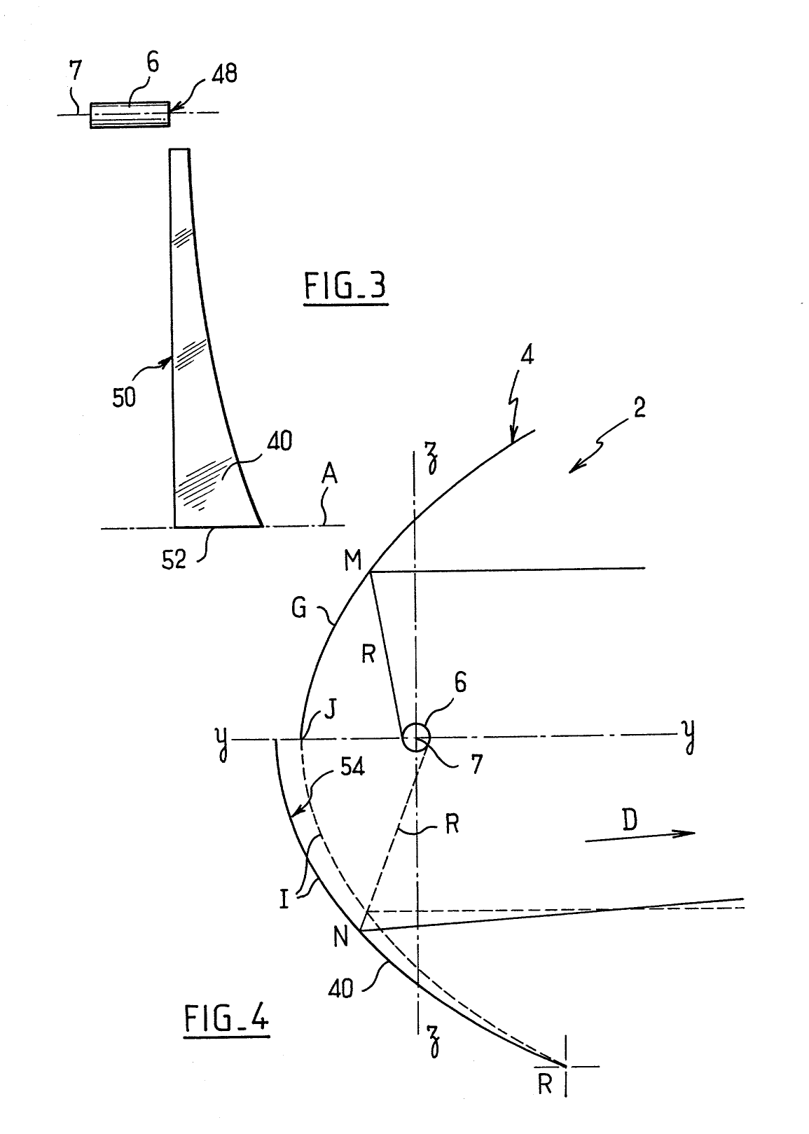

FIG. 3, showing the effect of orientation of the first sector by rotation.

### DESCRIPTION OF A PREFERRED EMBODIMENT OF THE INVENTION

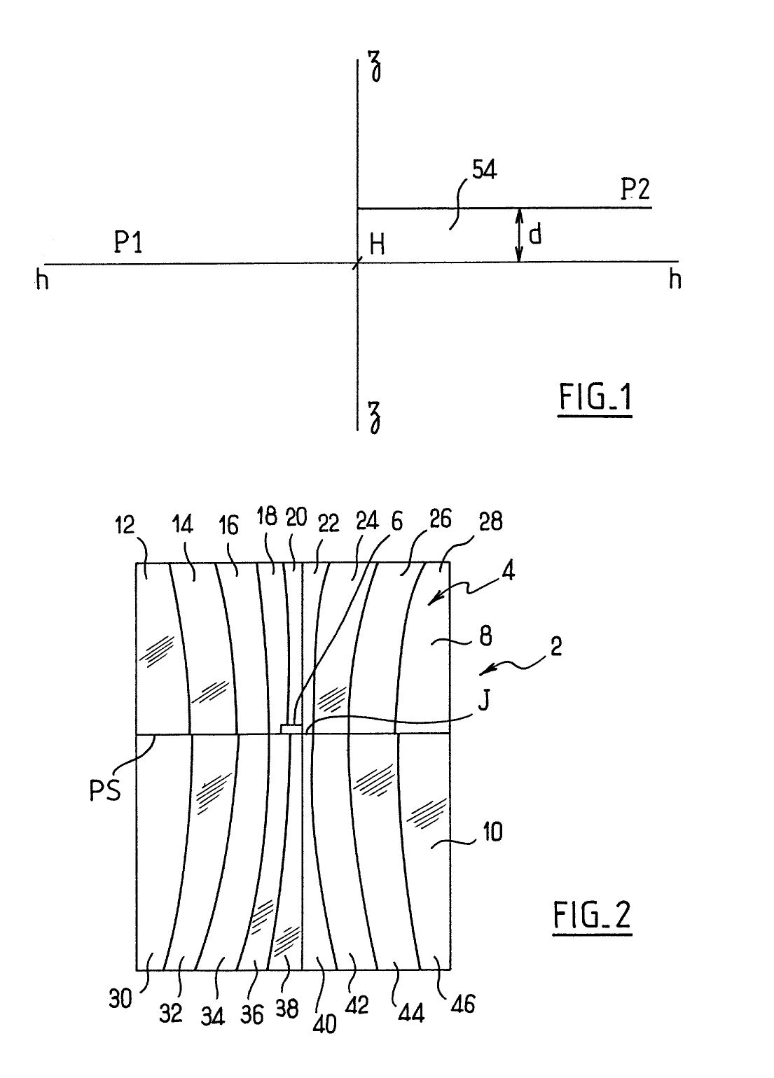

FIG. 1 shows the cut-off line of an American passing beam, i.e. an illuminating beam of the dipped or passing type which conforms to current United States regulations. In its upper part, this beam is cut off by two horizontal half planes P1 and P2 having the median vertical line y-y as their common limit. The half plane P1 on the left extends to the height of the horizon line h-h. The half plane P2 on the right extends to a height greater than P1, the difference in height being indicated by d.

Referring now to FIG. 2, this shows diagrammatically a reflector 4 for a headlight 2 according to the invention. The headlight has a light source 6 of generally cylindrical form, having an axis 7 which is horizontal and transverse to the horizontal optical axis y-y of the headlight and reflector. The light source may be the filament of an incandescent lamp, or the arc of a discharge lamp. The reflector 4 is defined geometrically essentially in the manner described in the above mentioned French patent specification No. 2 774 149 in the name of the Company Valeo Vision, with reference to FIG. 6 and all of FIGS. 1 to 5 in that document. Reference should be made to the above mentioned French patent specification for full details as to the definition of the reflector. Here, the following essential points will merely be summarised. The invention consists in a modification of this basic reflector, as will be explained later herein.

The reflector has a horizontal plane PS passing close to the light source 6. The plane PS defines an upper zone 8 and a lower zone 10 of the reflector, and the latter has, in general terms, a larger surface than the upper zone. Each zone is divided into a certain number of sectors, which are of generally rectangular form or (preferably) trapezoidal, with their major axis essentially vertical. In this example these sectors are numbered in pairs as 12 to 18 in the upper zone, and 30 to 46 in the lower zone.

All the sectors are arranged to reflect the light from the light source 6 in such a way that the images, orientations of which vary according to the point on the reflector concerned, are all situated level with the horizon line h-h over the whole beam. In this way a beam is obtained in which the cut-off line is well defined, and the beam gives good overall photometric distribution.

Without entering into unnecessary detail, it will be recalled that in order to obtain this result, each sector may be defined geometrically by a surface having a horizontal generatrix J (shown in FIGS. 2 and 4), which is for example of parabolic form, the surface being suitably defocused with respect to the source. With reference to FIG. 4, the surface may have a vertical generatrix G which is so defined that, or any point M on the generatrix, a light ray R which is emitted tangentially by an edge of the source 6 is reflected by this point parallel to the optical axis y-y. In addition, the rays emitted by the remainder of the source are reflected by the point M in a downward inclination with respect to the optical axis y-y. Each sector situated above or below the source therefore generates an image of the source 6, the highest point of which is situated on the horizon line h-h. The headlight in the preferred embodiment of the invention is modified in the following way as compared with this basic configuration just described.

Firstly, care is taken that one of the sectors in the lower half, here given the reference numeral 40, extends laterally beyond the right hand end 48 of the light source 6 when the reflector is seen from behind as in FIGS. 2 and 3. The sector 40 is, for the purposes of this non-limiting example, the one referred to sometimes in this specification and in the Claims as the “first sector”.

In addition, it is arranged that the sector 40 has a left hand vertical edge 50 which extends entirely in line with the end 48. In other words, the edge 50 represents the trace on the reflector 4 of a plane at right angles to the axis 7 of the light source and passing through the right hand end 48. Or again, it represents the projection of that end on the reflector in a direction radial to the axis of the source.

The sector 40 is then subjected to rotation, which in practice is notional. In practice, the sector 40 is disposed as if its position resulted from rotation of the sector, starting from its position of origin in the basic reflector described above, about an axis of rotation A which is oriented horizontally and transversely with respect to the optical axis, that is to say parallel to the light source. This axis A passes through the edge 52 which constitutes the lower end of the sector 40. The sector 40 is tilted backwards, that is to say behind the remainder of the reflector. This rotational movement is expressed by the arrow 54 in FIG. 4. While the sector 40 was initially continuous, without any detachment (that is to say at least of the order 1) with the laterally adjacent sectors 38 and 42 and the sector 22 above it (see FIG. 2), it is now detached from these adjacent sectors.

The reflector is of course not in reality manufactured by actually effecting this rotation physically. It is directly formed in its final position, that is to say its retracted position. The foregoing explanations aim merely to define the reflector in simple terms by comparison with the known prior art reflector. The person skilled in this technical field will be able to manufacture such a reflector directly, without any difficulty.

Because of the rotation, the optical properties of the sector 40 are modified. Thus, there is now a constant direction D which is such that, for any point N on the vertical generatrix I of this sector, the light ray R emitted tangentially by the edge of the source 6 is reflected by this point parallel to the direction D. This direction is essentially horizontal, but is inclined upwards with respect to the optical axis y-y. In the case of the sector 40, it replaces the direction of the optical axis y-y because of the rotation of the sector 40. As to the radiation emitted by the remainder of the light source, this is reflected by the point N, with a downward inclination with respect to the direction D. The radiation may therefore be reflected in an inclination situated somewhere between the direction D and the optical axis, or parallel to the optical axis, or again with a downward inclination with respect to the optical axis.

Referring to FIG. 1, the sector 40 and the angle of rotation are so chosen that the images produced by this sector are in the zone 54, which is defined in the upper part by the half plane P2, in the lower part by the horizontal half line H-h, and on the left by the vertical mid-line z-z. The images of this sector will then fill the zone 54 situated on the right between the horizon line and the cut-off line. The cut-off line is then fully defined, and the photometric distribution of the whole beam is generally good. In this connection, only the sector 40 generates images above the right hand horizon line, and all the other sectors illuminate only below the horizon line because they continue to behave as in the basic headlight.

The invention is particularly well adapted to the construction of reflectors having a height-to-width ratio greater than 1, and for example equal to 1.2 or 1.4. This ratio may however be as large as 4.

In this example, the sector 40 has been pivoted about its lower end in the anti-clockwise direction as seen from the left in FIG. 4. The sector 40 is then disposed behind the adjacent sectors. Alternatively, it can be envisaged that the sector is pivoted about its upper end (close to the axis y-y) in the same direction of rotation, so as again to “raise” the images. However, this arrangement has the disadvantage that it puts the sector in projecting relationship with the rest of the reflector, which can give rise to the propagation of uncontrolled radiation from the free edges of the sector 40. A further solution consists in rotating the sector 40 about an axis of rotation remote from the upper and lower ends of the sector, and being for example at mid-height in the sector 40. The amplitude by which it projects is then reduced. However, a lower portion of the sector does remain.

In a further embodiment, it can be arranged that the sector that undergoes rotation is a sector of the upper half 8 of the reflector, for example the sector 22 which is the next following sector to the sector 40 in the upward direction. In this case this sector can with advantage be caused to “turn” about an axis of rotation which passes through its lower end, towards the rear in the clockwise direction as seen from the left of the reflector in FIG. 4, so as to “raise” the images between the half plane P2 and the horizontal line H-h. Here again, the position of the axis of rotation can be varied along the sector.

In the present example, the reflector is able to generate by itself, that is to say without intervention of any cover lens, a passing beam in accordance with current United State regulations, with, in particular, the required horizontal width.

Some of the sectors in the reflector, and especially the central sectors 20 and 38 which produce images of the filament which are horizontal or very slightly inclined to the horizontal, are able to produce a horizontal cut-off line having a substantial extent. Their horizontal generatrix will then be preferably a straight line.

Preferably it is arranged that the horizontal generatrices of the homologous upper and lower sectors are coincident with each other so as to avoid discontinuities that are liable to produce optical errors. Each sector of the reflector could be constructed in a different way from that described above, provided that the resulting overall photometric distribution is satisfactory.

It can be arranged that at least some of the sectors of the reflector consist of portions of paraboloids.

As regards the sector obtained by rotation (the “first sector”), this sector could be defined by a small portion of a paraboloid. In this version, the surface of this sector could be defined by horizontal and vertical generatrices in the form of parabolas with different foci. In another version, the cover lens could include optical elements such as prisms or ribs adapted to cooperate with the sector obtained by rotation with a view to giving satisfactory photometric distribution.

The invention also enables a headlight to be made with two horizontal cut-off lines offset in height with respect to each other and adapted to generate a beam different from the American passing beam.

What is claimed is:

1. A vehicle headlight comprising: a reflector defining an optical axis, the headlight defining two horizontal half planes at different heights; and a horizontal light source oriented in relation to the reflector transversely to the said optical axis, the headlight being such as to generate a beam of light radiation from said light source reflected from the reflector, in which the light beam defines a cut-off delimited by the said half planes, wherein the headlight further defines a horizontal axis transverse to the said optical axis, the reflector being divided into a first sector and further sectors, the first sector being obtained geometrically by notional rotation of the first sector about the said horizontal axis transverse to the optical axis, from an initial position in which the first sector is continuous with adjacent said further sectors without discontinuity, the first sector being adapted to generate images situated at the limit of the upper of the two said half planes.

2. A headlight according to claim 1, wherein said further sectors are so arranged as to generate images of the light source all situated at heights in a range excluding heights above the limit of the lower of the two said half planes.

3. A headlight according to claim 1, wherein the said first sector defines a vertical generatrix defining a constant emission direction such that, for any point on the said generatrix, a light ray emitted tangentially by an edge of the light source is reflected by that point parallel to the emission direction, and the light rays emitted by the remainder of the light source are reflected by that point in a downward inclination with respect to the emission direction.

4. A headlight according to claim 1, wherein at least one said further sector of the reflector defines a vertical generatrix such that, for any point on the said generatrix, a light ray emitted tangentially by an edge of the light source is reflected by that point parallel to the optical axis, and the light rays emitted by the remainder of the light source are reflected by that point in a downward inclination with respect to the optical axis.

5. A headlight according to claim 1, defining a horizontal plane at the height of the lower of the two said half planes, all the said further sectors being such as to generate a portion of cut-off beam entirely delimited by the said horizontal plane.

6. A headlight according to claim 1, defining a horizontal plane extending at the height of the lower of the two said mid-planes, the headlight being adapted so that, if the said first sector occupied its said initial position, the headlight would produce a cut-off beam entirely delimited by the said horizontal plane.

7. A headlight according to claim 1, wherein the light source has a lateral end, the said first sector extending at least partly beyond the said lateral end.

8. A headlight according to claim 1, wherein the light source has a lateral end, the said first sector having a vertical edge in line with the said lateral end.

9. A headlight according to claim 1, wherein the reflector includes a lower half, the said first sector extending into the said lower half.

10. A headlight according to claim 1, wherein the reflector has an upper edge and a lower edge and defines an essentially horizontal plane passing close to the said light source, the said first sector extending between one of said edges of the reflector and the said essentially horizontal plane.

11. A headlight according to claim 1, wherein the said first sector has, as seen in front elevation, a generally trapezoidal form defining a generally vertical major axis.

12. A headlight according to claim 1, wherein the said axis of rotation extends to a lower end of the said first sector.

13. A headlight according to claim 1, wherein at least one said sector of the reflector has a parabolic, essentially horizontal, generatrix.

14. A headlight according to claim 1, wherein the reflector defines a height greater than its width.
